(19) United States
(12) Patent Application Publication
(10) Pub. No.: US 2011/0076474 A1
(43) Pub. Date: Mar. 31, 2011

(54) NANOCOMPOSITE COMPOSITION AND SYSTEM

(75) Inventors: Javed A. Mapkar, Farmington Hills, MI (US); Edward J. Hummelt, Greenfield, WI (US); James P. Barnhouse, Perrysburg, OH (US)

(73) Assignee: Eaton Corporation, Cleveland, OH (US)

(21) Appl. No.: 12/888,891

(22) Filed: Sep. 23, 2010

Related U.S. Application Data
(60) Provisional application No. 61/245,776, filed on Sep. 25, 2009.

(51) Int. Cl. B32B 5/00; C08K 3/34

(52) U.S. Cl. 428/213; 524/451; 977/700

(57) ABSTRACT

A nanocomposite composition includes a polymer and a barrier component sufficiently dispersed within the polymer so as to define a tortuous path within the polymer. The barrier component includes a nano-constituent including a plurality of layers and a macro-constituent including a plurality of particles. Each of the plurality of layers has a first average thickness and each of the plurality of particles has a second average thickness that is greater than the first average thickness. A nanocomposite system includes a substrate and a coating disposed on the substrate and formed from the nanocomposite composition.

### CROSS-REFERENCE TO RELATED APPLICATIONS

This application claims the benefit of U.S. Provisional Patent Application No. 61/245,776, filed Sep. 25, 2009, which is hereby incorporated by reference in its entirety.

### TECHNICAL FIELD

The present disclosure generally relates to a nanocomposite composition.

### BACKGROUND

Gas transport through a polymer may be modeled according to a solution-diffusion mechanism, and may be expressed as a permeability of the polymer, i.e., a rate at which gas passes through the polymer. For example, during gas transport through the polymer, a gas molecule may dissolve into the polymer from a region of relatively high pressure, diffuse through a thickness of the polymer, and desorb from a surface of the polymer to a region of comparatively low pressure. Permeability may therefore be affected by the diffusivity of the gas molecule within the polymer.

Such diffusivity may be expressed as a diffusivity coefficient, i.e., a measure of a mobility of the gas molecule within the polymer. As the diffusivity coefficient decreases, permeation of the gas molecule through the polymer also decreases, and gas transport through the polymer is slowed.

### SUMMARY

A nanocomposite composition includes a polymer and a barrier component sufficiently dispersed within the polymer so as to define a tortuous path within the polymer. The barrier component includes a nano-constituent including a plurality of layers and a macro-constituent including a plurality of particles. Each of the plurality of layers has a first average thickness, and each of the plurality of particles has a second average thickness that is greater than the first average thickness.

A nanocomposite system includes a substrate and a coating disposed on the substrate. The coating is formed from the nanocomposite composition.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic illustration of a magnified portion of a nanocomposite composition including a barrier component dispersed within a polymer;

FIG. 2 is a schematic illustration of a magnified portion of the nanocomposite composition of FIG. 1, wherein the barrier component defines a tortuous path configured to inhibit gas permeation through the nanocomposite composition;

FIG. 3 is a schematic cross-sectional illustration of a nanocomposite system including a coating formed from the nanocomposite composition of FIGS. 1 and 2 disposed on a substrate;

FIG. 4 is a graphical representation of four x-ray diffraction spectra corresponding to a nanocomposite composition of each of Example 1 and Comparative Examples 3-5; and

FIG. 5 is a graphical representation of gas permeability for a rubber of Control 6 and a nanocomposite composition of each of Examples 1 and 2 and Comparative Examples 4 and 5.

### DETAILED DESCRIPTION

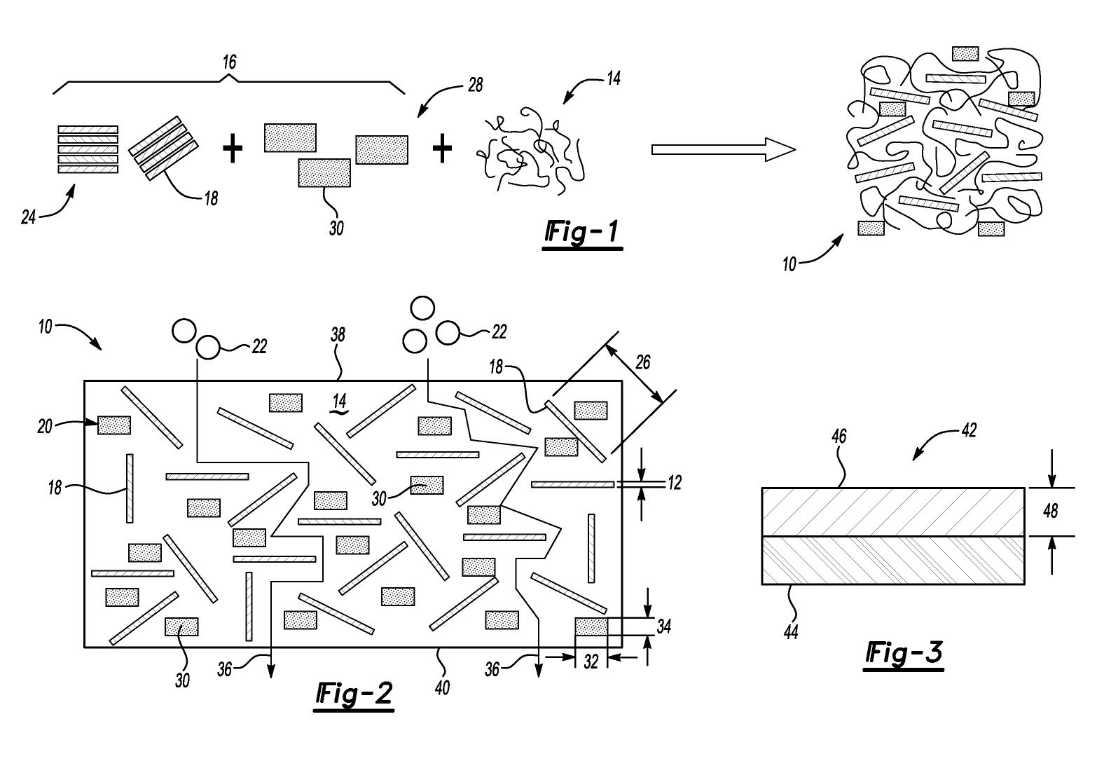

Referring to the Figures, wherein like reference numerals refer to like elements, a schematic illustration of a magnified portion of a nanocomposite composition 10 is shown generally in FIG. 1. The nanocomposite composition 10 may be useful for applications requiring materials having decreased gas permeability, and excellent elongation at break, tensile strength, and modulus of elasticity, as set forth in more detail below. For example, the nanocomposite composition 10 may be useful for automotive applications including, but not limited to, accumulator bladders, diaphragm bladders, pressure pulsation dampener bladders, hydraulic hoses, fuel hoses, and fuel tanks. However, the nancocomposite composition 10 may also be useful for non-automotive applications including, but not limited to, packaging, foodstuff liners, containers, electronics, and other agricultural, construction, and industrial applications.

As used herein, the terminology “nanocomposite composition” refers to a material in which at least one constituent has one or more dimensions, such as length, width, or first average thickness 12 (FIG. 2), measurable on a nanometer scale, i.e., in a nanometer size range. One nanometer is equal to 1×10⁻⁹ meters.

Referring again to FIG. 1, the nanocomposite composition 10 includes a polymer 14. In general, the polymer 14 may provide structure to the nanocomposite composition 10 and may be a carrier for other components of the nanocomposite composition 10, as set forth in more detail below. Therefore, the polymer 14 may be selected according to required properties of a desired application. For example, the polymer 14 may be selected to have excellent tensile strength and/or elongation at break. The polymer 14 may be an elastomer, such as, but not limited to, rubber. For example, the polymer 14 may be selected from the group including epichlorohydrin, acrylonitrile-butadiene rubber, hydrogenated acrylonitrile-butadiene rubber, natural rubber, fluorocarbon rubber, ethylene propylene diene monomer (EPDM/EPR), butyl rubber, chlorobutyl rubber, chlorinated polyethylene, and combinations thereof.

As described with continued reference to FIG. 1, the nanocomposite composition 10 also includes a barrier component 16 sufficiently dispersed within the polymer 14 so as to define a tortuous path 36 (FIG. 2) within the polymer 14, as set forth in more detail below. As used herein, the terminology “barrier component” refers to a material or material structure, such as a layer 18 (FIG. 2) or a surface 20 (FIG. 2), that obstructs and/or impedes the penetration, permeation, diffusion, dissolution, movement, transport, and/or desorption of gas molecules (represented generally by 22 in FIG. 2) through or beyond the material or material structure. The barrier component 16 may be thoroughly mixed within the polymer 14 so as to be uniformly dispersed throughout the polymer 14. For example, any two separate regions of the polymer 14 may include a substantially uniform quantity of the barrier component 16. Alternatively, the barrier component 16 may be randomly dispersed within the polymer 14. For example, any two separate regions may include different quantities of the barrier component 16.

Referring again to FIG. 1, the barrier component 16 includes a nano-constituent 24 including a plurality of layers 18. As used herein, the terminology “nano-constituent” refers to a constituent of the barrier component 16 having one or more dimensions, such as length, width, or first average thickness 12 (FIG. 2), measurable on the nanometer scale, i.e., in the nanometer size range.

As shown in FIG. 2, each of the plurality of layers 18 has a first average thickness 12. In particular, the first average thickness 12 may be from about 0.5 nm to about 2 nm, e.g., about 1 nm. Layers 18 having a first average thickness 12 of less than about 0.5 nm may decrease the effectiveness of the barrier component 16 so that gas permeation through the polymer 14 is not properly impeded. Similarly, layers 18 having a first average thickness 12 of greater than about 2 nm may decrease effective dispersion of the nano-constituent 24 within the nanocomposite composition 10. Each of the plurality of layers 18 may have a non-spherical shape, e.g., a platelet-like shape, and may have a length 26 (FIG. 2) that is longer than the first average thickness 12 of the layer 18. That is, each of the plurality of layers 18 may have an aspect ratio of from about 100:1 to about 1,000:1, e.g., about 200:1. As used herein, the terminology “aspect ratio” refers to a ratio of a longer dimension to a shorter dimension of the layer 18, e.g., a ratio of the length 26 to the first average thickness 12 of the layer 18.

In one variation, the nano-constituent 24 (FIG. 1) may include a silicate having a plurality of non-ordered layers 18, as set forth in more detail below. The silicate may be selected from the group including montmorillonite, bentonite, hectorite, saphonite, vermiculite, and combinations thereof. In one example described with reference to FIG. 1, the nano-constituent 24 may include individual layers 18 of the silicate that are each separated and dispersed throughout the polymer 14. That is, the silicate may be initially procured as layered clay or nanoclay in preparation for forming the nanocomposite composition 10, and may be characterized as 2:1 phyllosilicate. However, for the prepared nanocomposite composition 10, the individual layers 18 of the silicate may be separated and dispersed within the polymer 14, as set forth in more detail below.

In another variation, the nano-constituent 24 may include a carbon-based platelet-type nanoparticle. For example, the nano-constituent 24 may include grapheme. The nano-constituent 24 may have a first average thickness 12 (FIG. 2) of about 1 nm and a length 26 (FIG. 2) of less than about 1 micron.

The nano-constituent 24 may be present in an amount of from about 0.1 parts by weight to about 100 parts by weight based on 100 parts of the polymer 14. In one example, the nano-constituent 24 may be present in an amount of from about 20 parts by weight to about 40 parts by weight based on 100 parts by weight of the polymer 14. At amounts less than about 0.1 parts by weight, the barrier component 16 may not effectively impede gas permeation in the polymer 14, and at amounts greater than about 100 parts by weight, the barrier component 16 may not sufficiently disperse within the polymer 14. A suitable nano-constituent 24 is commercially available from Nanocor Inc. of Arlington Heights, Ill., under the trade name Nanomer®.

In one variation, the nano-constituent 24 may be chemically modified. Chemical modification of the nano-constituent 24 may improve the dispersion and/or the adhesion of the nano-constituent 24 within the polymer 14. That is, chemical modification of the nano-constituent 24 may improve compatibility with the polymer 14 (FIG. 2). In particular, chemical modification of the layers 18 of the nano-constituent 24 may attract the polymer 14 to spaces between adjacent layers 18 (FIG. 2) of the nano-constituent 24 to thereby fill the interlayer spacing between individual layers 18 of the nano-constituent 24.

In one example, the nano-constituent 24 may be chemically modified via an ion-exchange reaction to replace a hydrated cation on a surface of the layers 18 of the nano-constituent 24. For example, the layers 18 of the nano-constituent 24 may be modified by a surfactant, a monomer group, and/or combinations thereof. A suitable surfactant includes alkylamonium. Suitable monomer groups include ammonium salt, octadecylamine, hydrogenated tallow-bis(2-hydroxyethyl) methyl ammonium salt, methyl-tallow-bis(2-hydroxyethyl) quaternary ammonium salt, octadecyltrimethyl ammonium salt, dimethyl hydrogenated tallow 2-ethylhexyl quaternary ammonium salt, and combinations thereof.

Referring again to FIG. 1, the barrier component 16 also includes a macro-constituent 28 including a plurality of particles 30. As used herein, the terminology “macro-constituent” refers to a constituent of the barrier component 16 having one or more dimensions, such as length 32 (FIG. 2), width, or second average thickness 34 (FIG. 2), measurable on a scale greater than the nanometer scale, e.g., a micron scale. That is, one or more dimensions of the barrier component 16 may be in the micron size range. One micron is equal to 1×10⁻⁶ meters. Therefore, the macro-constituent 28 is thicker than the nano-constituent 24.

As shown in FIG. 2, each of the plurality of particles 30 has a second average thickness 34. In particular, the second average thickness 34 may be from about 0.1 micron to about 100 microns, e.g., from about 1.7 microns to about 50 microns. Particles 30 having a second average thickness 34 of less than about 0.1 micron may decrease the effectiveness of the barrier component 16 so that gas permeation through the polymer 14 is not properly impeded. Likewise, particles 30 having a second average thickness 34 of greater than about 100 microns may decrease effective dispersion of the macro-constituent 28 within the nanocomposite composition 10. Each of the plurality of particles 30 may have a non-spherical shape, e.g., platy, and may have a length 32 (FIG. 2) that is longer than the second average thickness 34 of the particle 30. That is, each of the plurality of particles 30 may have an aspect ratio of from about 10:1 to about 30:1, e.g., about 20:1.

Referring to FIGS. 1 and 2, the macro-constituent 28 may be selected from the group including talc, mica, i.e., phyllosilicate of aluminum or potassium, graphite, and combinations thereof. In one variation, the macro-constituent 28 may include talc, i.e., hydrated magnesium silicate, which may be represented as Mg₂Si₄O₁₀(OH)₂. The macro-constituent 28 may have a second average thickness 34 (FIG. 2) of about 1 micron and a length 32 (FIG. 2) of about 20 microns. The macro-constituent 28 may be present in an amount of from about 0.1 parts by weight to about 60 parts by weight based on 100 parts of the polymer 14. In one example, the macro-constituent 28 may be present in an amount of from about 10 parts by weight to about 20 parts by weight based on 100 parts by weight of the polymer 14. At amounts of less than about 0.1 parts by weight, the barrier component 16 may not effectively impede gas permeation in the polymer 14, and at amounts of greater than about 60 parts by weight, the barrier component 16 may not sufficiently disperse within the polymer 14. A suitable macro-constituent 28 is commercially available from Luzenac Inc. of Greenwood Village, Colo., under the trade name Mistron® Vapor R talc.

In one variation, the macro-constituent 28 may be chemically modified. Chemical modification of the macro-constituent 28 may improve compatibility with the nano-constituent 24 and/or the polymer 14. The macro-constituent 28 may be chemically modified with a silane such as, but not limited to, an organosilane. Suitable silanes include methyltrimethoxysilane, aminopropyltriethoxysilane, diaminosilane, triaminosilane, and combinations thereof. However, the macro-constituent 28 may be substantially free from chemical modification by an alkyl ammonium salt so as not to interfere with compatibility of the nano-constituent 24 and the polymer 14.

Without intending to be limited by theory, the macro-constituent 28 may exfoliate the nano-constituent 24 of the barrier component 16. As used herein, the terminology “exfoliate” or “exfoliated” refers to individual layers 18 of the nano-constituent 24 dispersed throughout a carrier material, e.g., the polymer 14. Generally, “exfoliated” denotes a highest degree of separation of layers 18 of the nano-constituent 24 and is contrasted with intercalated layers 18 as defined below. Likewise, the terminology “exfoliation” refers to a process for forming an exfoliated nano-constituent 24 from an intercalated or otherwise less-dispersed state of separation of the layers 18 of the nano-constituent 24. In contrast, the terminology “intercalate” or “intercalated” refers to a layered constituent having merely increased interlayer spacing between adjacent layers 18, i.e., interlayer spacing that is less than the interlayer spacing of the exfoliated nano-constituent 24. Stated differently, exfoliated nano-constituent 24 represents the highest level of dispersion of the individual layers 18 of nano-constituent 24 within the polymer 14.

Referring again to FIGS. 1 and 2, the nano-constituent 24 may be exfoliated and dispersed within the polymer 14. More specifically, the polymer 14 may be interdisposed between the plurality of non-ordered layers 18, as best shown at 10 in FIG. 1. That is, referring to FIG. 2, the layers 18 of the nano-constituent may be separated by the polymer 14 and generally have a large interlayer spacing as compared to a non-exfoliated, e.g., intercalated, constituent. For example, the interlayer spacing between each individual layer 18 of the nano-constituent 24 may be from about 4 nm to about 6 nm.

Further, the nano-constituent 24 may be uniformly dispersed within the polymer 14. That is, although an orientation of the individual layers 18 of the nano-constituent 24 may differ in two separate regions of the nanocomposite composition 10 as shown in FIG. 2, the two separate regions may include an equal amount of the nano-constituent 24.

Likewise, the macro-constituent 28 may be uniformly dispersed within the polymer 14. That is, two separate regions of the nanocomposite composition 10 may include an equal amount of the macro-constituent 28. Alternatively, the macro-constituent 28 may be randomly dispersed within the polymer 14. That is, two separate regions of the nanocomposite composition 10 may include differing amounts or concentrations of the macro-constituent 28.

As best shown in FIGS. 1 and 2, the nano-constituent 24 (FIG. 1) and the macro-constituent 28 (FIG. 1) may together define the tortuous path (represented generally by arrows 36 in FIG. 2) or passage within the polymer 14 configured to inhibit gas permeation through the nanocomposite composition 10. That is, the macro-constituent 28 may exfoliate the nano-constituent 24 and provide for increased interlayer spacing between adjacent individual layers 18 of the nano-constituent 24. Further, the macro-constituent 28 may be disposed between such individual layers 18 of the nano-constituent 24 so as to interfill a portion of the interlayer spacing. Therefore, the nano-constituent 24 and the macro-constituent 28 may together inhibit gas permeation through the nanocomposite composition 10.

More specifically, as described with reference to FIG. 2, as a gas molecule 22 enters the polymer 14 from a comparatively higher pressure feed side 38 of the polymer 14 and attempts diffusion through the nanocomposite composition 10, each of the plurality of layers 18 of the nano-constituent 24 (FIG. 1) and the plurality of particles 30 of the macro-constituent 28 (FIG. 1) impede the progress of the gas molecule 22 towards a comparatively lower pressure permeate side 40 of the polymer 14. That is, the gas molecule 22 may be obstructed by the nano-constituent 24 and the macro-constituent 28 within the polymer 14.

In addition, the macro-constituent 28 (FIG. 1) may lubricate individual polymer chains of the polymer 14, reduce compound viscosity of the polymer 14, and thereby improve processing characteristics of the polymer 14. Further, the macro-constituent 28 may shear the nano-constituent 24 (FIG. 1) within the polymer 14. In addition, the combination of the nano-constituent 24 and the macro-constituent 28 within the polymer 14 may create a synergistic effect that encourages each of the nano-constituent 24 and the macro-constituent 28 to uniformly disperse within the polymer 14. Without intending to be limited by theory, such uniform dispersal within the polymer 14 may also effectively decrease gas permeation through the polymer 14.

The nanocomposite composition 10 (FIG. 1) may further include one or more additives and/or curing agents. Suitable additives include, but are not limited to, fillers, dyes, plasticizers, antioxidants, activators, and combinations thereof. Suitable curing agents include vulcanizing agents, crosslinking agents, organic peroxides, and combinations thereof.

Referring now to FIG. 3, a nanocomposite system 42 includes a substrate 44 and a coating 46 disposed on the substrate 44. The coating 46 is formed from the nanocomposite composition 10 (FIG. 1), as set forth above. That is, the nanocomposite composition 10 may be disposable on the substrate 44 in the form of the coating 46.

The coating 46 may be applied to the substrate 44 via any suitable process and/or device. For example, the coating 46 may be sprayed or roll-coated onto the substrate 44. In addition, the coating 46 may have a thickness 48 of from about 5 microns to about 1,000 microns. Further, the substrate 44 may be any suitable material configured for supporting the coating 46. The substrate 44 may be selected from the group including elastomers, e.g., rubber, fabric, e.g., woven para-aramid synthetic fiber, and combinations thereof.

Referring again to FIG. 1, a method of forming the nanocomposite composition 10 includes combining the polymer 14 and the barrier component 16 to form a blend, and mixing the blend to sufficiently exfoliate and disperse the nano-constituent 24 within the polymer 14 so as to define the tortuous path 36 (FIG. 2) within the polymer 14 and thereby form the nanocomposite composition 10. The polymer 14 and the barrier component 16 may be combined in any order. For example, the polymer 14 may be added to the barrier component 16, or the barrier component 16 may be added to the polymer 14. More specifically, the nano-constituent 24, macro-constituent 28, and polymer 14 may be combined simultaneously, or may each be added to the other in any order to form the blend. Further, the polymer 14 and the barrier component 16 may be combined in solid form. That is, the resulting blend may be non-aqueous.

The polymer 14 and the barrier component 16 may be mixed by any suitable process and/or apparatus. By way of non-limiting examples, mixing may include processes selected from the group including melt mixing, extruding, shear mixing, pulverizing, solution casting, compounding, and combinations thereof. That is, mixing may sufficiently interdisperse the nano-constituent 24 and the macro-constituent 28 within the polymer 14 so that the macro-constituent 28 may shear and/or exfoliate the nano-constituent 24 to thereby define the tortuous path 36 (FIG. 2) within the polymer 14 configured to inhibit gas permeation through the nanocomposite composition 10. Further, the polymer 14 and the barrier component 16 may be combined and mixed on full-scale production equipment. That is, the method provides for full-scale production of the nanocomposite composition 10 and is not limited to bench- or lab-scale equipment or batch sizes.

The method may further include chemically modifying each of the plurality of layers 18. For example, the individual layers 18 may be chemically modified to improve the dispersion, adhesion, and/or compatibility of the nano-constituent 24 (FIG. 1) within the polymer 14. In particular, chemically modifying the nano-constituent 24 may attract the polymer 14 to interlayer spacing between adjacent layers 18 of the nano-constituent 24 to thereby fill the interlayer spacing between individual layers 18 of the nano-constituent 24.

In one example, the nano-constituent 24 (FIG. 1) may be chemically modified via an ion-exchange reaction to replace a hydrated cation of the nano-constituent 24. For example, the nano-constituent 24 may be modified by a surfactant, a monomer group, and/or combinations thereof, as set forth above.

The method may further include chemically modifying each of the plurality of particles 30 (FIG. 1). Chemically modifying of the macro-constituent 24 (FIG. 1) may improve compatibility of the macro-constituent 28 (FIG. 1) with the nano-constituent 24 and/or the polymer 14. In one example, the macro-constituent 28 may be chemically modified with a silane such as, but not limited to, an organosilane, as set forth above. However, the macro-constituent 28 may not be chemically modified by an alkyl ammonium salt so as not to diminish compatibility of the nano-constituent 24 and the polymer 14.

The method may also include combining the blend and one or more additives and/or curing agents. Suitable additives include, but are not limited to, fillers, dyes, plasticizers, antioxidants, activators, and combinations thereof. Suitable curing agents include vulcanizing agents, crosslinking agents, organic peroxides, and combinations thereof.

The nanocomposite composition 10 and system 42 exhibit decreased gas permeability. In particular, the nano-constituent 24 and the macro-constituent 28 interact to impede gas transport through the polymer 14. As such, the nanocomposite composition 10 and system 42 are useful for applications requiring materials having decreased gas permeability, and excellent elongation at break, tensile strength, and modulus of elasticity.

The following examples are meant to illustrate the disclosure and are not to be viewed in any way as limiting to the scope of the disclosure.

### EXAMPLES

To prepare the nanocomposite compositions of Examples 1 and 2 and Comparative Examples 3-5, components A-G are combined in the amounts listed in Table 1. Specifically, the nanocomposite compositions of each of Examples 1 and 2 and Comparative Examples 4 and 5 are prepared by compounding component B and/or component C in component A with Additives D and E in a Banbury Mixer BR 1600 at a rotor speed of 55 revolutions per minute for 5 minutes to prepare respective homogeneous blends. Additive F and Curing AgenteG are combined with each of the homogeneous blends and mixed for an additional 2 minutes to form the respective nanocomposite compositions of Examples 1 and 2 and Comparative Examples 4 and 5. Each of the resulting nanocomposite compositions is mixed on a roll mill to form a sheet, and cured to form plaques for evaluation according to the test methods set forth below. The amounts of components B-G listed in Table 1 refer to parts by weight based on 100 parts by weight of component A.

TABLE 1
Nanocomposite Compositions

| | | | Comp. | Comp. | Comp. |
|---|---|---|---|---|---|
| | Ex. 1 | Ex. 2 | Ex. 3 | Ex. 4 | Ex. 5 |
| Component A | 100 | 100 | — | 100 | 100 |
| Component B | 10 | 20 | 100 | 20 | 40 |
| Component C | 20 | 20 | — | — | — |
| Additive D | 50 | 50 | 50 | 50 | 50 |
| Additive E | 2.5 | 2.5 | 2.5 | 2.5 | 2.5 |
| Additive F | 5 | 5 | 5 | 5 | 5 |
| Curing Agent G | 5 | 5 | 5 | 5 | 5 |

Component A is hydrogenated acrylonitrile-butadiene rubber commercially available from Zeon Chemicals L.P. of Louisville, Ky., under the trade name Zetpol®.

Component B is 2:1 layered phyllosilicate and includes a plurality of layers each having a first average thickness of 1 nm. Component B is commercially available from Nanocor Inc. of Arlington Heights, Ill., under the trade name Nanomer®.

Component C is hydrated magnesium silicate, i.e., talc, and includes a plurality of particles each having a second average thickness of 50 microns. Component C is commercially available from Luzenac Inc. of Greenwood Village, Colo., under the trade name Mistron® Vapor R talc.

Additive D is carbon black. Component D is commercially available from Columbian Chemicals Company of Marietta, Ga.

Additive E is 4,4′-bis dimethylbenzyl diphenylamine. Component E is commercially available from Chemtura Corporation of Middlebury, Conn.

Additive F is a combination of zinc oxide, commercially available under the trade name Kadox® 911 from Horsehead Corporation of Monaca, Pa., and stearic acid, commercially available under the trade name INDUSTRENE® R from Akrochem Corporation of Akron, Ohio.

Curing Agent G is 1,1′-bis(t-butylperoxy)-diisopropylbenzene. Curing Agent G is commercially available from GEO® Specialty Chemicals of Gibbstown, N.J., under the trade name Vul-Cup® 40KE.

After compounding, the resulting nanocomposite compositions of Example 1, Comparative Example 4, and Comparative Example 5 have a thickness of 500 microns.

In contrast, the nanocomposite composition of Example 2 is roll-coated onto a natural rubber substrate to form a nanocomposite system including a coating disposed on the substrate. The resulting coating formed from the nanocomposite composition of Example 2 has a thickness of 750 microns, and the natural rubber substrate has a thickness of 2 cm.

Each of the nanocomposite compositions of Examples 1 and 2 and Comparative Examples 3-5 is evaluated according to the test procedures set forth below.

### X-Ray Diffraction

Each of the nanocomposite compositions of Examples 1 and 2 and Comparative Examples 3-5 is evaluated to determine an interlayer spacing between the plurality of layers of component B on a Scintag XDS2000 diffractometer in a Bragg-Brentano geometry. Each nanocomposite composition is scanned in a continuous symmetric scan with a step size of 0.02° at a scan rate of 0.5°/min. The scan range in 20 is from 1° to 10°. The tube and director fixed slits are 0.3°, 0.5° and 1°, 0.2°, respectively. The x-ray radiation is a CuK_{α1}, λ=1.5418 Å. Patterns and data are processed with MDI JADE 9+ software.

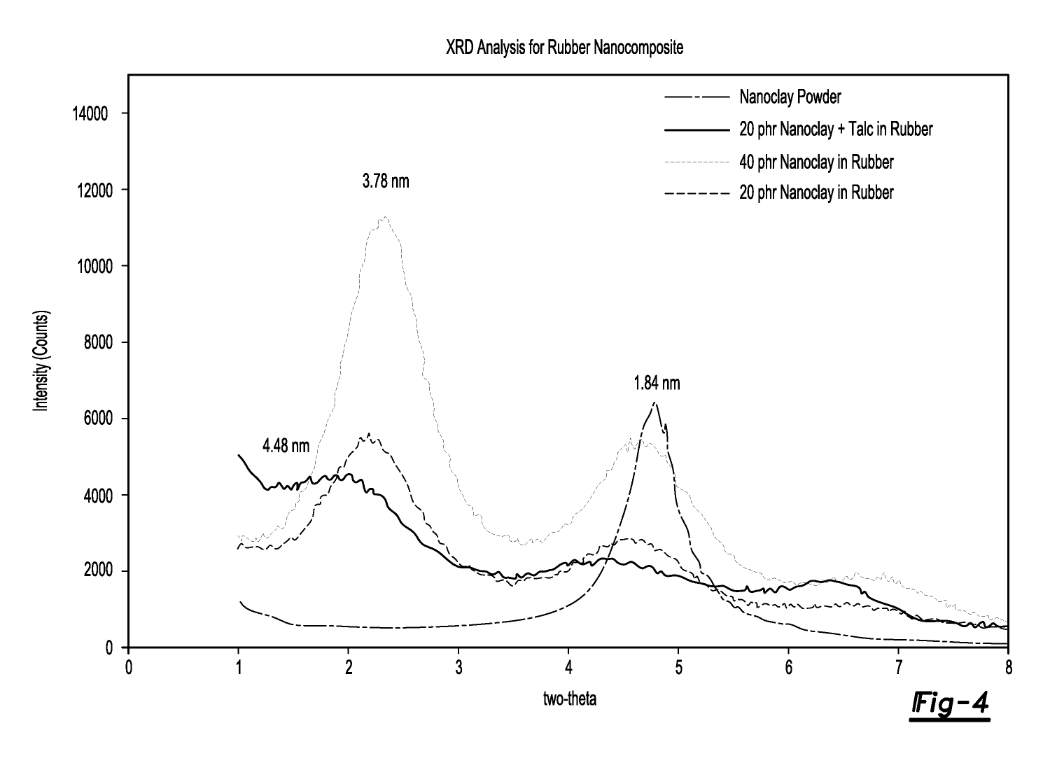

FIG. 4 is a graphical representation of four x-ray diffraction spectra of the nanocomposite compositions of each of Example 1 and Comparative Examples 3-5, wherein θ is a scattering angle of the x-ray beam. Each peak of the x-ray diffraction spectra corresponds to atomic distances and interlayer spacing of the nanocomposite compositions.

Referring to FIG. 4, the x-ray spectra of the nanocomposite composition of Comparative Example 3 indicates one peak at 1.84 nm. That is, the interlayer spacing between the plurality of layers of component B is 1.84 nm. In contrast, the x-ray spectra of the nanocomposite compositions of Comparative Examples 4 and 5, which include component B compounded in component A, indicates two peaks; a first peak is at 1.84 nm and a second peak is at 3.78 nm. Therefore, some of the interlayer spacing between the plurality of layers of the nanocomposite compositions of Comparative Examples 4 and 5 is greater than 1.84 nm. The two peaks indicate an expanded interlayer structure, and as such, the nanocomposite compositions of Comparative Examples 4 and 5 are intercalated.

By comparison, described with continued reference to FIG. 4, the x-ray spectra of the nanocomposite composition of Example 1, which includes both phyllosilicate (component B) and talc (component C), is free from a sharp peak at both 1.84 nm and 3.78 nm. Rather, the x-ray spectra of the nanocomposite composition of Example 1 indicates a broad peak at 4.48 nm and prominent scattering for 2θ of less than 2. That is, the nanocomposite composition of Example 1 includes irregular packing and spacing of the plurality of layers of the phyllosilicate (component B). Therefore, the nanocomposite composition of Example 1 is exfoliated rather than intercalated. Without intending to be limited by theory, since Example 1 includes both phyllosilicate (component B) and talc (component C), the talc may exfoliate the phyllosilicate (component B) and provide for increased interlayer spacing between adjacent individual layers of the phyllosilicate (component B).

### Gas Permeability

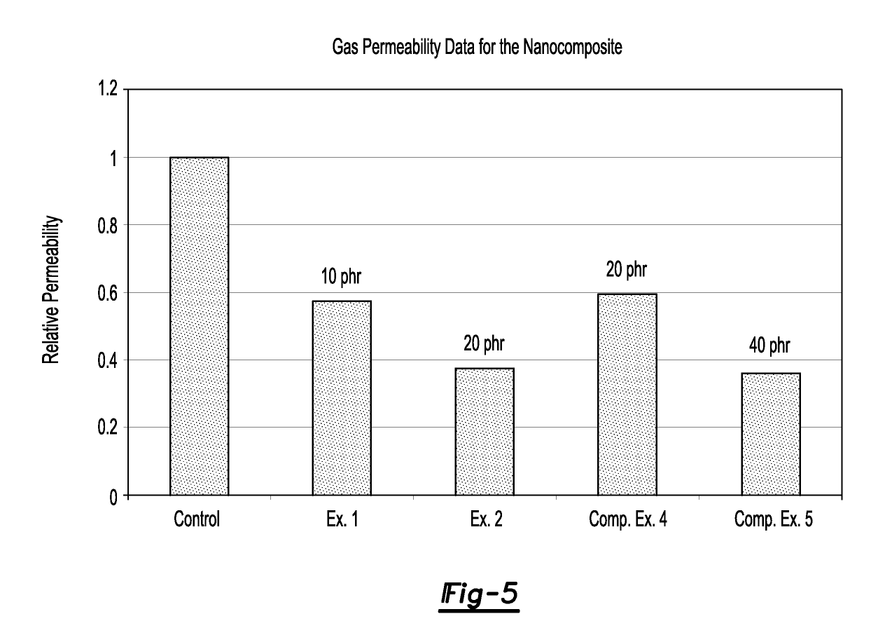

The nanocomposite compositions of each of Examples 1 and 2 and Comparative Examples 4 and 5 are evaluated for gas permeability at 23° C. and 80° C. according to test method ASTM D 1434-82. Control 6, a hydrogenated acrylonitrile-butadiene rubber, is also evaluated for gas permeability according to the aforementioned test method and compared to the nanocomposite compositions of each of Example 1 and 2 and Comparative Examples 4 and 5. The results of the gas permeability testing are illustrated in FIG. 5.

The nanocomposite compositions of Examples 1 and 2, which include both phyllosilicate (component B) and talc (component C), have a lower gas permeability than the rubber of Control 6. In comparison, the nanocomposite compositions of each of Comparative Examples 4 and 5 have higher gas permeability than the nanocomposite compositions of Examples 1 and 2 for the same loading of phyllosilicate (component B). As such, the nanocomposite compositions of Examples 1 and 2 exhibit improved gas permeability as compared to the nanocomposite compositions of Comparative Examples 4 and 5.

### Tensile Strength

The nanocomposite compositions of each of Examples 1 and 2 and Comparative Examples 4 and 5 are evaluated for tensile strength according to test method ASTM D 412. Control 6, a hydrogenated acrylonitrile-butadiene rubber, is also evaluated for tensile strength according to the aforementioned test method and compared to the nanocomposite compositions of each of Examples 1 and 2 and Comparative Examples 4 and 5. The results of the tensile strength testing are listed in Table 2.

TABLE 2
Tensile Strength

| | |
|---|---|
| Ex. 1 | 2,880 psi |
| Ex. 2 | 2,680 psi |
| Comp. Ex. 4 | 2,998 psi |
| Comp. Ex. 5 | 2,610 psi |
| Control 6 | 2,928 psi |

The nanocomposite compositions of Examples 1 and 2, which include both phyllosilicate (component B) and talc (component C), have a comparable tensile strength to the rubber of Control 6. The addition of component B and component C does not significantly decrease the tensile strength of the nanocomposite compositions of Examples 1 and 2 as compared to the rubber of Control 6.

### Elongation at Break

The nanocomposite compositions of each of Examples 1 and 2 and Comparative Examples 4 and 5 are evaluated for elongation at break according to test method ASTM D 412. Control 6, a hydrogenated acrylonitrile-butadiene rubber, is also evaluated for elongation at break according to the aforementioned test method and compared to the nanocomposite compositions of each of Examples 1 and 2 and Comparative Examples 4 and 5. The results of the elongation at break testing are listed in Table 3.

TABLE 3
Elongation at Break

| | |
|---|---|
| Ex. 1 | 430% |
| Ex. 2 | 400% |
| Comp. Ex. 4 | 469% |
| Comp. Ex. 5 | 408% |
| Control 6 | 426% |

The nanocomposite compositions of Examples 1 and 2, which include both phyllosilicate (component B) and talc (component C), and Comparative Examples 4 and 5 have an acceptable elongation at break when compared to the rubber of Control 6. As such, the inclusion of both phyllosilicate (component B) and talc (component C) in the nanocomposite composition of Example 1 does not unacceptably decrease elongation at break.

### Modulus of Elasticity

The nanocomposite compositions of each of Examples 1 and 2 and Comparative Examples 4 and 5 are evaluated for modulus of elasticity at 50% strain according to test method ASTM D 412. Control 6, a hydrogenated acrylonitrile-butadiene rubber, is also evaluated for modulus of elasticity at 50% strain according to the aforementioned test method and compared to the nanocomposite compositions of each of Example 1 and Comparative Examples 4 and 5. The results of the modulus of elasticity testing are listed in Table 4.

TABLE 4
Modulus of Elasticity

| | |
|---|---|
| Ex. 1 | 498 psi |
| Ex. 2 | 742 psi |
| Comp. Ex. 4 | 507 psi |
| Comp. Ex. 5 | 713 psi |
| Control 6 | 215 psi |

The nanocomposite compositions of Examples 1 and 2, which include both phyllosilicate (component B) and talc (component C), have a higher modulus of elasticity than the rubber of Control 6. As such, the nanocomposite compositions of Examples 1 and 2 exhibit a greater modulus of elasticity than the nanocomposite compositions of Comparative Examples 4 and 5 for the same loading of component B.

While the best modes for carrying out the disclosure have been described in detail, those familiar with the art to which this disclosure relates will recognize various alternative designs and embodiments for practicing the disclosure within the scope of the appended claims.

1. A nanocomposite composition comprising:
a polymer; and
a barrier component sufficiently dispersed within the polymer so as to define a tortuous path within the polymer, the barrier component including;
a nano-constituent including a plurality of layers, wherein each of the plurality of layers has a first average thickness; and
a macro-constituent including a plurality of particles, wherein each of the plurality of particles has a second average thickness that is greater than the first average thickness.

2. The nanocomposite composition of claim 1, wherein the nano-constituent is exfoliated and dispersed within the polymer.

3. The nanocomposite composition of claim 2, wherein the nano-constituent is uniformly dispersed within the polymer.

4. The nanocomposite composition of claim 1, wherein the nano-constituent includes a silicate having a plurality of non-ordered layers.

5. The nanocomposite composition of claim 4, wherein the polymer is interdisposed between the plurality of non-ordered layers.

6. The nanocomposite composition of claim 1, wherein the nano-constituent and the macro-constituent together define the tortuous path within the polymer configured to inhibit gas permeation through the nanocomposite composition.

7. The nanocomposite composition of claim 1, wherein the first average thickness is from about 0.5 nm to about 2 nm.

8. The nanocomposite composition of claim 7, wherein each of the plurality of layers has an aspect ratio of from about 100:1 to about 1,000:1.

9. The nanocomposite composition of claim 7, wherein the second average thickness is from about 0.1 micron to about 100 microns.

10. The nanocomposite composition of claim 1, wherein the macro-constituent is uniformly dispersed within the polymer.

11. The nanocomposite composition of claim 1, wherein the macro-constituent is randomly dispersed within the polymer.

12. The nanocomposite composition of claim 1, wherein the nano-constituent is present in an amount of from about 0.1 parts by weight to about 100 parts by weight based on 100 parts by weight of said polymer.

13. The nanocomposite composition of claim 1, wherein the macro-constituent includes talc.

14. A nanocomposite system comprising:
a substrate; and
a coating disposed on the substrate and formed from a nanocomposite composition, wherein the nanocomposite composition includes;
a polymer; and
a barrier component sufficiently dispersed within the polymer so as to define a tortuous path within the polymer, the barrier component including;
a nano-constituent including a plurality of layers, wherein each of the plurality of layers has a first average thickness; and
a macro-constituent including a plurality of particles, wherein each of the plurality of particles has a second average thickness that is greater than the first average thickness.

15. The nanocomposite system of claim 14, wherein the coating has a thickness of from about 5 microns to about 1,000 microns.
